(19) United States
(12) Patent Application Publication
(10) Pub. No.: US 2016/0350302 A1
(43) Pub. Date: Dec. 1, 2016

(54) DYNAMICALLY SPLITTING A RANGE OF A NODE IN A DISTRIBUTED HASH TABLE

(71) Applicant: Hedvig, Inc., Santa Clara, CA (US)

(72) Inventor: Avinash LAKSHMAN, Fremont, CA (US)

(21) Appl. No.: 14/723,380

(22) Filed: May 27, 2015

(51) Int. Cl. G06F 17/30

(52) U.S. Cl. CPC G06F 17/3033; G06F 17/30424

(57) ABSTRACT

A range of a node is split when the data stored upon that node reaches a predetermined size. A split value is determined such that roughly half of the key/value pairs stored upon the node have a hash result that falls to the left of the split value and roughly half have a hash result that falls to the right. A key/value pair is read by computing the hash result of the key, dictating the node and the sub-range. Only those files associated with that sub-range need be searched. A key/value pair is written to a storage platform. The hash result determines on which node to store the key/value pair and to which sub-range the key/value pair belongs. The key/value pair is written to a file; the file is associated with the sub-range to which the pair belongs. A file includes any number of pairs.

### FIELD OF THE INVENTION

The present invention relates generally to a distributed hash table (DHT). More specifically, the present invention relates to splitting the range of a DHT associated with a storage node based upon accumulation of data.

### BACKGROUND OF THE INVENTION

In the field of data storage, enterprises have used a variety of techniques in order to store the data that their software applications use. Historically, each individual computer server within an enterprise running a particular software application (such as a database or e-mail application) would store data from that application on any number of attached local disks. Later improvements led to the introduction of the storage area network in which each computer server within an enterprise communicated with a central storage computer node that included all of the storage disks. The application data that used to be stored locally at each computer server was now stored centrally on the central storage node via a fiber channel switch, for example.

Currently, storage of data to a remote storage platform over the Internet or other network connection is common, and is often referred to as “cloud” storage. With the increase in computer and mobile usage, changing social patterns, etc., the amount of data needed to be stored in such storage platforms is increasing. Often, an application needs to store key/value pairs. A storage platform may use a distributed hash table (DHT) to determine on which computer node to store a given key/value pair. But, with the sheer volume of data that is stored, it is becoming more time consuming to find and read a particular key/value pair from a storage platform. Even when a particular computer node is identified, it can be very inefficient to scan all of the key/value pairs on that node to find correct one.

Accordingly, new techniques are desired to make the storage and retrieval of key/value pairs from storage platforms more efficient.

### SUMMARY OF THE INVENTION

To achieve the foregoing, and in accordance with the purpose of the present invention, a technique is disclosed that splits the range of a node in a distributed hash table in order to make reading key/value pairs more efficient.

By splitting a range into two or more sub-ranges, it is not necessary to look through all of the files of a computer node that store key/value pairs in order to retrieve a particular value. Determining the hash value of a particular key determines in which sub-range the key belongs, and accordingly, which files of the computer node should be searched in order to find the value corresponding to the key.

In a first embodiment, the range of a node is split when the amount of data stored upon that node reaches a certain predetermined size. By splitting at the predetermined size, the amount of data that must be looked at to find a value corresponding to a key is potentially limited by the predetermined size. A split value is determined such that roughly half of the key/value pairs stored upon the node have a hash result that falls to the left of the split value and roughly half have a hash result falls to the right. Data structures keep track of these sub-ranges, the hash results contained within these sub-ranges, and the files of key/value pairs associated with each sub-range.

In a second embodiment, a key/value pair is read from a storage platform by first computing the hash result of the key. The hash result dictates the computer node and the sub-range. Only those files associated with that sub-range need be searched. Other files on that computer node storing key/value pairs need not be searched, thus making retrieval of the value more efficient.

In a third embodiment, a key/value pair is written to a storage platform. Computation of the hash result determines on which node to store the key/value pair and to which sub-range the key/value pair belongs. The key/value pair is written to a file and this file is associated with the sub-range to which the key/value pair belongs. A file may include any number of key/value pairs.

### BRIEF DESCRIPTION OF THE DRAWINGS

The invention, together with further advantages thereof, may best be understood by reference to the following description taken in conjunction with the accompanying drawings in which:

FIG. 1 illustrates a data storage system according to one embodiment of the invention having a storage platform.

FIG. 2 illustrates use of a distributed hash table in order to implement an embodiment of the present invention.

FIG. 3 illustrates how a particular range of the distributed hash table may be split into sub-ranges as the amount of data stored within that range reaches the predetermined size.

FIG. 4 is a flow diagram describing an embodiment in which a key/value pair may be written to one of many nodes within a storage platform.

FIG. 5 is a flow diagram describing one embodiment by which a range or sub-range of a node may be split.

FIG. 6 is a flow diagram describing an embodiment in which a value is read from a storage platform.

FIG. 7 illustrates an example of a range manager data structure for a range corresponding to a computer node.

FIG. 8 illustrates a range manager data structure of a node for a range that has been split.

FIG. 9 illustrates one embodiment of storing key/value pairs.

FIG. 10 illustrates a file compaction example.

FIGS. 11 and 12 illustrate a computer system suitable for implementing embodiments of the present invention.

### DETAILED DESCRIPTION OF THE INVENTION

### Storage System

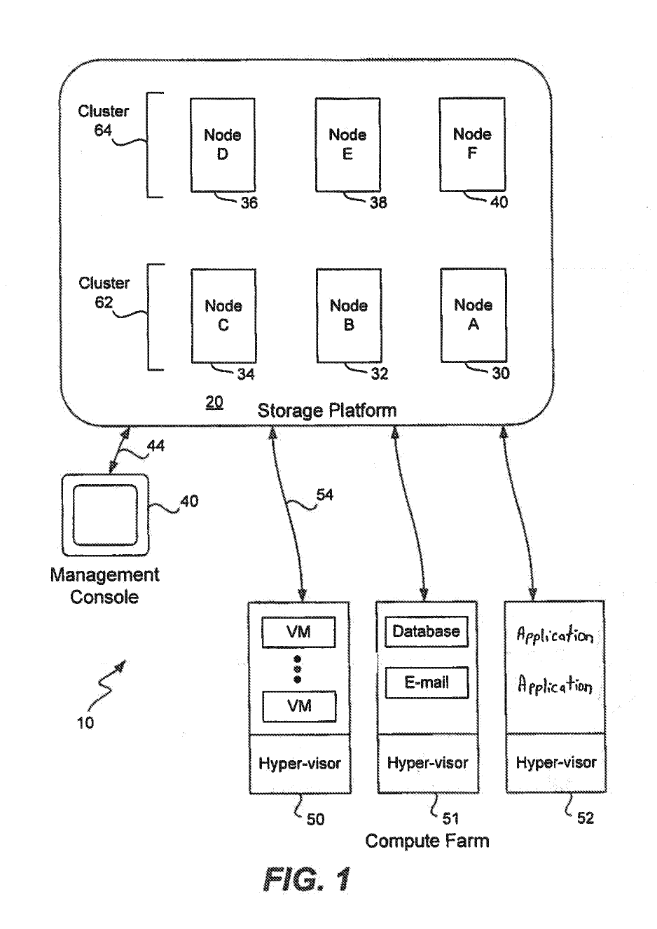

FIG. 1 illustrates a data storage system 10 having a storage platform 20 in which one embodiment of the invention may be implemented. Included within the storage platform 20 are any number of computer nodes 30-40. Each computer node of the storage platform has a unique identifier (e.g., “A”) that uniquely identifies that computer node within the storage platform. Each computer node is a computer having any number of hard drives and solid-state drives (e.g., flash drives), and in one embodiment includes about twenty disks of about 1 TB each. A typical storage platform may include on the order of about 81 TB and may include any number of computer nodes. A platform may start with as few as three nodes and then grow incrementally to as large as 1,000 nodes or more.

Computers nodes 30-40 are shown logically being grouped together, although they may be spread across data centers and may be in different geographic locations. A management console 40 used for provisioning virtual disks within the storage platform communicates with the platform over a link 44. Any number of remotely-located computer servers 50-52 each typically executes a hypervisor in order to host any number of virtual machines. Server computers 50-52 form what is typically referred to as a compute farm. As shown, these virtual machines may be implementing any of a variety of applications such as a database server, an e-mail server, etc., including applications from companies such as Oracle, Microsoft, etc. These applications write data to and read data from the storage platform using a suitable storage protocol such as iSCSI or NFS, although each application will not be aware that data is being transferred over link 54 using a generic protocol implemented in one specific embodiment.

Management console 40 is any suitable computer able to communicate over an Internet connection 44 with storage platform 20. When an administrator wishes to manage the storage platform he or she uses the management console to access the storage platform and is put in communication with a management console routine executing on any one of the computer nodes within the platform. The management console routine is typically a Web server application.

Advantageously, storage platform 20 is able to simulate prior art central storage nodes (such as the VMax and Clariion products from EMC, VMWare products, etc.) and the virtual machines and application servers will be unaware that they are communicating with storage platform 20 instead of a prior art central storage node. This application is related to U.S. patent application Ser. Nos. 14/322,813, 14/322,832, 14/322,850, 14/322,855, 14/322,867, 14/322,868 and 14/322,871, filed on Jul. 2, 2014, entitled “Storage System with Virtual Disks,” and to U.S. patent application Ser. No. 14/684,086 (Attorney Docket No. HEDVP002X1), filed on Apr. 10, 2015, entitled “Convergence of Multiple Application Protocols onto a Single Storage Platform,” which are all hereby incorporated by reference.

### Splitting of a Range of a Distributed Hash Table

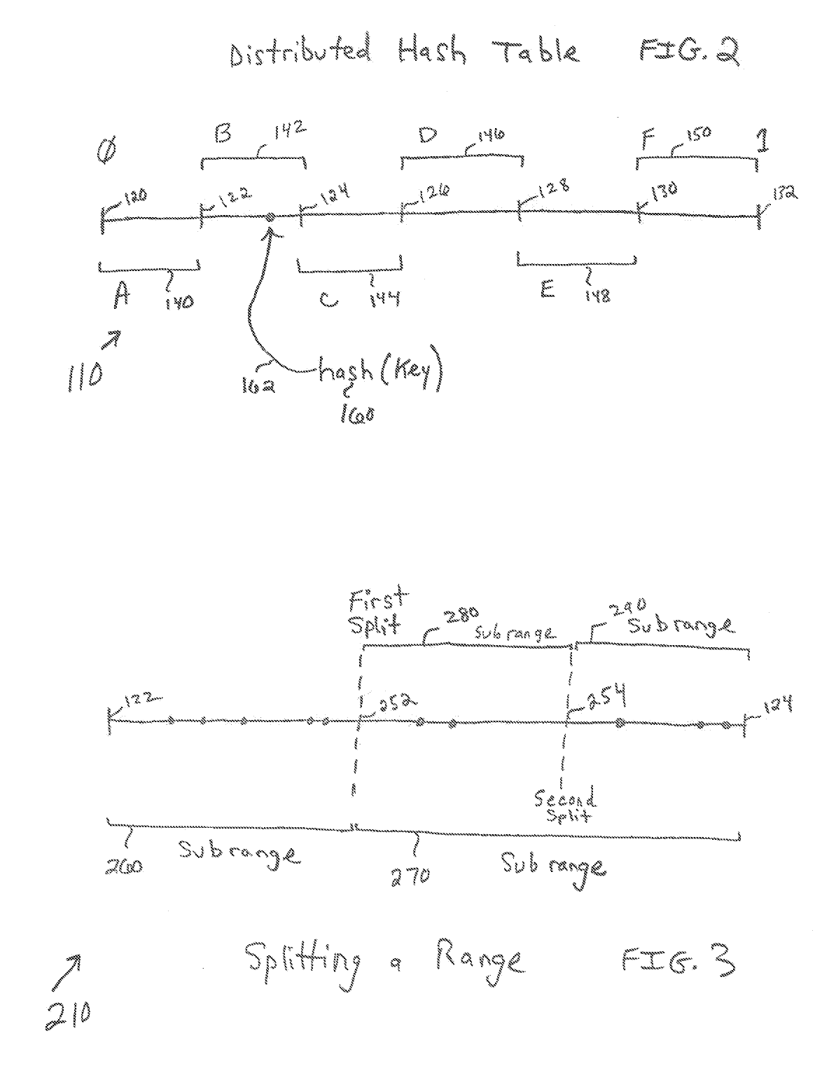

FIG. 2 illustrates use of a distributed hash table 110 in order to implement an embodiment of the present invention. As known in the art, often a key/value pair is needed to be stored into persistent storage and the value later retrieved; a hash function is used to map a particular key into a particular hash result, which is then used to store the value into a location dictated by the hash result. In this case, a hash function (or hash table) maps a key to different computer nodes for storage (or for retrieval) of the value.

In this simple example, the values of possible results from the hash function are from 0 up to 1, which is divided up into six ranges, each range corresponding to one of the computer nodes A, B, C, D, E or F within the platform. For example, the range 140 of results from 0 up to point 122 corresponds to computer node A, and the range 142 of results from point 122 up to point 124 corresponds to computer node B. The other four ranges 144-150 correspond to the other nodes C-F within the platform. Of course, the values of possible results of the hash function may be quite different than values from 0 to 1, any particular hash function or table may be used (or similar functions), and there may be any number of nodes within the platform.

Shown is use of a hash function 160. In this example, a hash of a particular key results in a hash result 162 that falls in range 142 corresponding to node B. Thus, if a value associated with that particular key is desired to be stored within (or retrieved from) the platform, this example shows that the value will be stored within node B. Other hash results from different keys result in values being stored on different nodes.

Unfortunately, the sheer quantity of data (i.e., key/value pairs) that may be stored upon storage platform 20, and thus upon any of its computer nodes, can make retrieval of key/value pairs slow and inefficient.

The key/value pairs stored upon a particular computer node (i.e., within its persistent storage, such as its computer disks) may be stored within a database, within tables, within computer files, or within another similar storage data structure, and multiple pairs may be stored within a single data structure or there may be one pair per data structure. When a particular key/value pair needs to be retrieved from a particular computer node (as dictated by use of the hash function and the distributed hash table) it is inefficient to search for that single key/value pair amongst all of the key/value pairs stored upon that computer node because of the quantity of data. For example, the amount of data associated with storage of key/value pairs on a typical computer node in a storage platform can be on the order of a few Terabytes or more.

Even though the result of the hash function tells the storage platform on which computer node the key/value pair is stored, there is no other information given to that computer node to help narrow down the search. The computer node takes the key, in the case of a read operation, and must search through all of the keys stored upon that node in order to find the corresponding value to be read and returned to a particular software application (for example). Because key/value pairs are typically stored within a number of computer files stored upon a node, the computer node must search within each of its computer files that contain key/value pairs.

The present invention provides techniques that minimize the number of files that need to be looked at in order to find a particular key so that the corresponding value can be read. In one particular embodiment, for a given key, the amount of data that must be looked at in order to find that key is bounded by a predetermined size.

Referring again to FIG. 2, over time the use of hash function 160 will result in key/value pairs being stored across any or all of the computer nodes A-F, and a situation may result in which the amount of key/value pair data stored on computer node B approaches a certain predetermined size. Once this size is reached, range 142 will be split into two sub-ranges and computer node B will keep track of which of its computer files correspond to which of these two sub-ranges. Future data to be stored is stored within a computer file corresponding to the particular sub-range of the hash result, and upon a read operation, the computer node knows which computer files to look into based upon the sub-range of the hash result. Accordingly, the amount of data through which a computer node must search in order to find a particular key is bounded by the predetermined size.

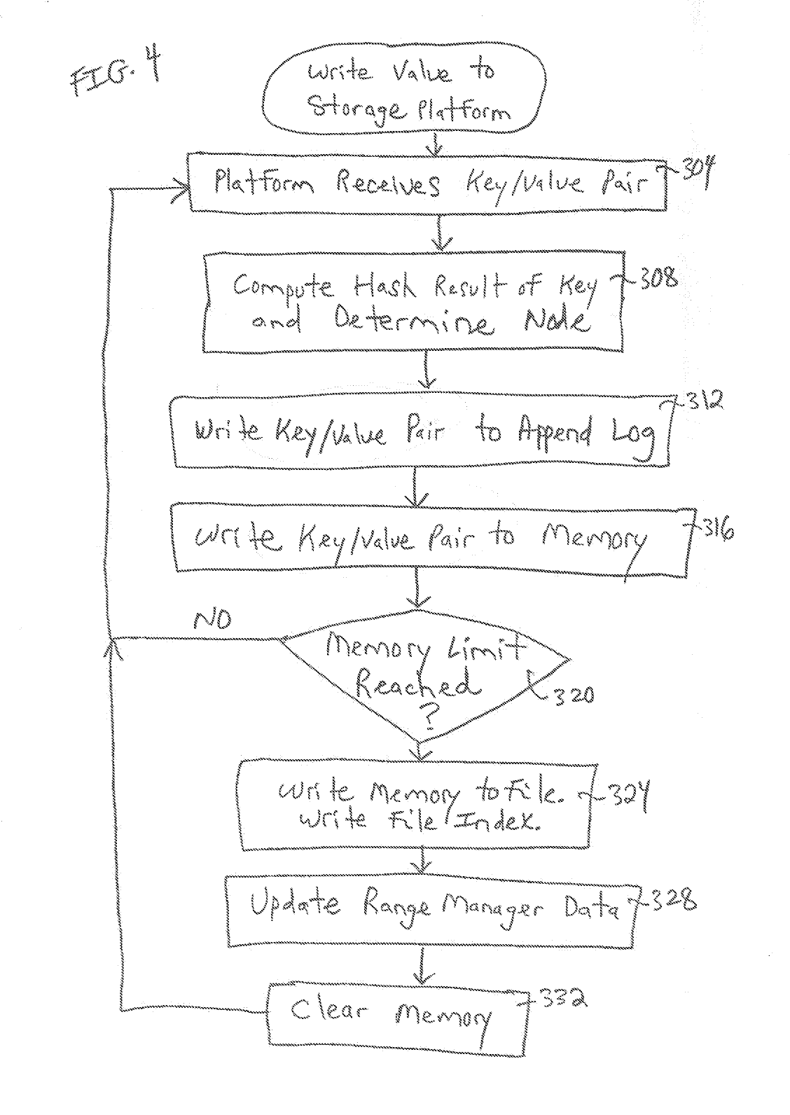

FIG. 3 illustrates how a particular range of the distributed hash table may be split into sub-ranges as the amount of data stored within that range reaches the predetermined size. Shown is range 142 corresponding to possible hash results from point 122 through point 124 for key/value pairs stored upon computer node B. At a given point in time, for example, there may be ten key/value pairs that have been stored; data points for the hash results of these key/value pairs are shown along this range. Assuming that the amount of stored data corresponding to these ten key/value pairs has reached the predetermined size, the range is now split into two sub-ranges, namely sub-range 260 and sub-range 270. This first split occurs at point 252 along the range and preferably occurs at a point such that half of the stored data has hash results that fall to the left of point 252 and half of the stored data has hash results that fall to the right of point 252. As shown, five of the hash results fall to the left and five of the hash results fall to the right. Thus, if the predetermined size is a value N, then N/2 of the data corresponds to sub-range 260 and N/2 corresponds to sub-range 270. It is not strictly necessary that the first split occur at a point such that N/2 of the data falls on either side, although such a split is preferred in terms of minimizing the number of splits and the number of sub-ranges needed in the future, and in terms of maximizing the efficiency of performing read operations.

At a later point in time after more key/values have been stored on node B, the number of hash results having values that fall between point 252 and point 124 increases such that the amount of data corresponding to sub-range 270 now reaches the predetermined size N. Therefore, a second split occurs at point 254 and sub-range 270 is split into two sub-ranges, namely sub-range 280 and sub-range 290. Again, the data corresponding to each of these new sub-ranges will be N/2, although different quantities may be used. Sub-range 270 now ceases to exist and computer node B now keeps track of three sub-ranges, namely sub-range 260, sub-range 280 and sub-range 290. The computer node is aware of which computer files storing the key/value pair data are associated with each of these sub-ranges, thus making retrieval of key/value pairs more efficient. For example, when searching for a particular key whose hash result falls within sub-range 280, computer node B need only search within the file or files associated with that sub-range, rather than searching in all of its files corresponding to all of the three sub-ranges.

### Writing Key/Value Pairs

FIG. 4 is a flow diagram describing an embodiment in which a key/value pair may be written to one of many nodes within a storage platform; a node may be one of the nodes as shown in FIG. 1. In step 304 a write request with a key/value pair is sent to storage platform 20 over communication link 54 using a suitable protocol. The write request may originate from any source, although in this example it originates with one of the virtual machines executing upon one of the computer servers 50-52. The write request includes a “key” identifying data to be stored and a “value” which is the actual data to be stored.

In step 308 one of the computer nodes of the platform receives the write request and determines to which storage node of the platform the request should be sent. Alternatively, a dedicated computer node of the platform (other than a storage node) receives all write requests. More specifically, a software module executing on the computer node takes the key from the write request, calculates a hash result using a hash function, and then determines to which node the request should be sent using a distributed hash table (for example, as shown in FIG. 2). Preferably, a software module executing on each computer node uses the same hash function and distributed hash table in order to route write requests consistently throughout the storage platform. For example, the module may determine that the hash result falls between 122 and 124; thus, the write request is forwarded to computer node B.

Next, in step 312 the key/value pair is written to an append log in persistent storage of computer node B. Preferably, the pair is written in log-structured fashion and the append log is an immutable file. Other similar transaction logs may also be used. Each computer storage node of the cluster has its own append log and a pair is written to the appropriate append log according to the distributed hash table. The purpose of the append log is to provide for recovery of the pairs if the computer node crashes.

In step 316 the same key/value pair is also written to a memory location of computer node B in preparation for writing a collection of pairs to a file. The pairs written to this memory location of the node are preferably sorted by their hash results. In step 320 it is determined if a predetermined limit has been reached for the number of pairs stored in this memory location. If not, then control returns to step 304 and more key/value pairs that are received for this computer node are written to its append log and its memory location.

On the other hand, if, in step 320 it is determined that the memory limit for this node has been reached, then the key/value pairs stored in this memory location are written in step 324 into a new file in persistent storage of node B corresponding to the particular range determined in step 308. Any suitable data structure may be used to store these key/value pairs, such as a file, a database, a table, a list, etc.; in one specific embodiment, an SSTable is used. As known in the art, an SSTable provides a persistent, ordered, immutable map from keys to values, where both keys and values are arbitrary byte strings. Operations are provided to look up the value associated with a specified key, and to iterate over all key/value pairs in a specified key range.

In a preferred embodiment, the hash result for a particular key/value pair is also stored into the append log, into the memory location, and eventually into the file (SSTable) along with its corresponding key/value pair. Storage of the hash value in this way is useful for more efficiently splitting a range as will be described below. In one example, the memory limit may be a few Megabytes, although this limit may be configurable.

Also in step 324, an index of the file is also written and includes the lowest hash result and the highest hash result for all of the key/value pairs in the file. Reference may be made to this index when searching for a particular key or when splitting a range.

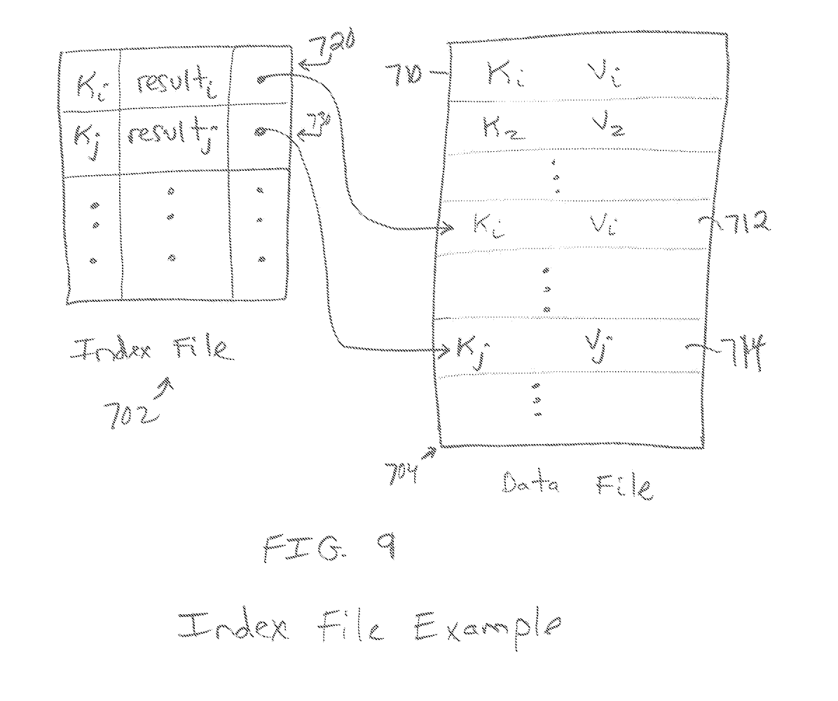

FIG. 9 illustrates one embodiment of storing key/value pairs. Shown is an index file 702 and a data file 704. Pairs (k,v) are written into the file as described above into rows 710. When a particular row k(i) 712 is written meaning that a certain amount of data has been written (e.g., every 16k bytes, for example, a configurable value), then an index row 720 is created in index file 702. This row 720 includes the key, k(i), the result, result(i), associated with that key, and a pointer to the actual key/value pair in row 712 of data file 704. As more data is written, and now 32k bytes has been reached when pair k(j)/v(j) is written, then an index row 730 is created in index file 702. This row 720 includes the key, k(j), the result, result(j), associated with that key, and a pointer to the actual key/value pair in row 714 of data file 704.

In step 328 the range manager data for the particular node determined in step 308 is updated to include a reference to this newly written file.

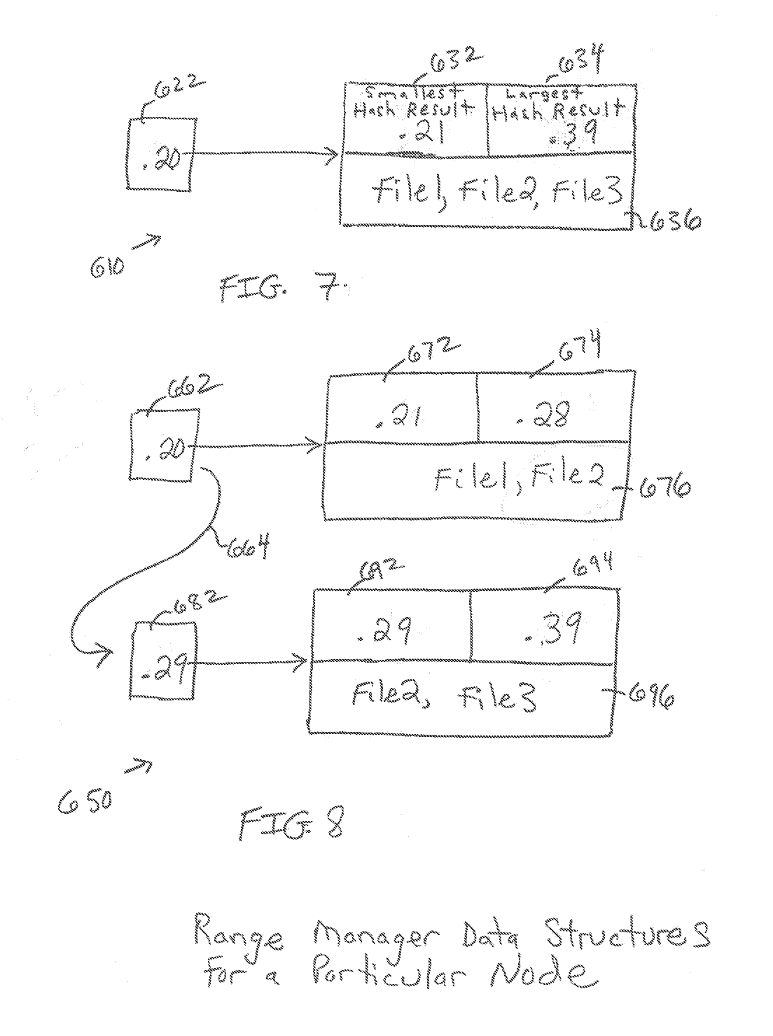

FIG. 7 illustrates an example of a range manager data structure 610 for range 142 corresponding to node B. In this simple example, range 142 encompasses hash results from 0.20 up to 0.40. The data structure for this range includes the minimum value for the range 622 with a pointer to other data values and identifiers. For example, the other values in this data structure include the smallest hash result 632 and the largest hash result 634 for key/value pairs that have been stored in files pertaining to this range. Identifiers for all the files holding key/value pairs whose hash results fall within that range are stored at 636. In this example, node B currently only has one range which has not yet been split, and there are three files (or SSTables) which hold key/value pairs for this range. Each of the other ranges of FIG. 2 also have similar data structures.

Accordingly, in step 328 an identifier for the newly written file is added to region 636. For example, if identifiers File1 and File2 already exist in region 636 (because these files have already been written), and File3 is the newly written file, then the identifier File3 is added. Further, fields 632 and 634 are updated if File3 includes a key/value pair having a smaller or larger hash result than is already present. In this fashion, the files that include key/value pairs pertaining to a particular range or sub-range may be quickly identified.

Finally, in step 332, as the contents of the memory location have been written to the file, the memory location is cleared (as well as the append log) and control returns to step 304 so that the computer node in question can continue to receive new key/value pairs to add to a new append log and into an empty memory location. It will be appreciated that the steps of FIG. 4 are happening continuously as the storage platform receives key/value pairs to be written, and that any of the computer storage nodes may be writing key/value pairs and updating its own range manager data structure in parallel. Each computer node has its own append log, memory location, and SSTables for use in storing key/value pairs.

Even if a range has been split, steps 304-324 occur as described. In step 328, the appropriate sub-range data structure or structures are updated to include an identifier for the new file. An identifier for the newly written file is added to a sub-range data structure if that file includes a key/value pair whose hash result is contained within that sub-range. FIG. 8 provides greater detail.

As the number of files (or SSTables) increase for a particular node, it may be necessary to merge these files. Periodically, two or more of the files may be merged into a single file using a technique termed file compaction (described below) and the resultant file will also be sorted by hash result. The index of the resultant file also includes the lowest and the highest hash result of the key/value pairs within that file.

### Splitting the Range of a Node

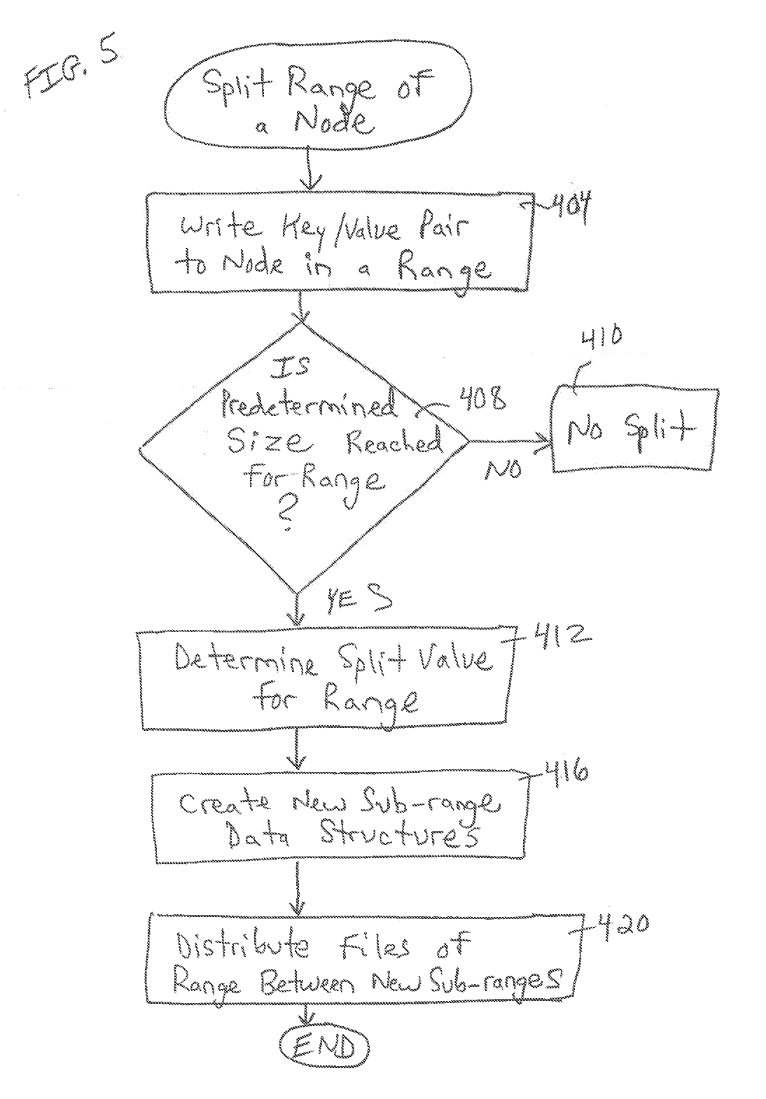

FIG. 5 is a flow diagram describing one embodiment by which a range or sub-range of a node may be split. As mentioned earlier, once the amount of data (i.e., key/value pairs) stored on a particular computer node for a particular range or sub-range of that node reaches a predetermined size than that range or sub-range may be split in order to provide an upper bound on the amount of data that must be looked at when searching for a particular key/value pair. Although the below discussion uses the simple example of splitting range 142 of computer node B into two sub-ranges, the technique is applicable to splitting sub-ranges as well into further sub-ranges (such as splitting sub-range 270 into sub-ranges 280 and 290).

In step 404 a next key/value pair is written to a particular computer node in the storage platform within a particular range. At this point in time, after a new pair has been written, a check may be performed to see if the amount of data corresponding to that range has reached the predetermined size. Of course, this check may be performed at other points in time or periodically for a particular node or periodically for the entire storage platform. Accordingly, in step 408 a check is performed to determine if the amount of data stored on a particular computer node for a particular range (or sub-range) of that node has reached the predetermined size. In one embodiment, the predetermined size is 16 Gigabytes, although this value is configurable. In order to determine if the predetermined size has been reached, various techniques may be used. For example, a running count is kept of how much data has been stored for a range of each node, and this count is increased each time pairs in memory are written to a file in step 324. Or, periodically, the sizes of all files pertaining to a particular range are added to determine the total size.

If the predetermined size has not been reached then in step 410 no split is performed and no other action need be taken. On the other hand, if the predetermined size has been reached then control moves to step 412. Step 412 determines at which point along the range that the range should be split into two new sub-ranges. For example, FIG. 3 shows that range 142 is split at point 252. Is not strictly necessary that a range be split in its center. In fact, preferably, a range is split such that roughly half of the key/value pairs pertaining to that range have a hash result falling to the left of the split point and roughly the other half have a hash result falling to the right. For example, if the predetermined size is 1 GB, then point 252 is chosen such that the amount of data associated with the key/value pairs that have a hash result falling to the left of point 252 is roughly 0.5 GB, and that the amount of data falling to the right is also roughly 0.5 GB.

FIG. 9 illustrates how the value of the split point may be determined in one embodiment. Assuming that the predetermined size is 16 GB for a node, the index file 702 is traversed from top to bottom until the row is reached indicating a point at which 8 GB has been stored. If each row represents 16k bytes, for example, it is a simple to determine which row represents the point at which 8 GB had been stored in the data file. The hash value result stored in that row is the split point as it indicates a point at which one half of the data has results below the split point and one half has results above the split point. Once the split point is determined, then in step 416 new sub-range data structures are created to keep track of the new sub-ranges and to assist with writing and reading key/value pairs.

FIG. 8 illustrates a range manager data structure 650 of a node for a range that has been split. This example assumes that range 142 of FIG. 3 is being split into sub-ranges 260 and 270. Before the split, FIG. 7 illustrates the range manager data structure representing range 142. In this example the split value is determined in step 412 to be 0.29. Accordingly, sub-range 260 extends from 0.20 up to 0.29, and sub-range 270 extends from 0.29 up to 0.40. Data structure 650 includes a first pointer 662 having a value of 0.20 which represents sub-range 260. This pointer indicates the smallest hash result 672 and the largest hash result 674 found within this sub-range. Note that even though this sub-range extends up to 0.29 the largest hash result found within the sub-range is only 0.28. Data structure 650 also includes a second pointer 682 having a value of 0.29 which represent sub-range 670. This pointer indicates the smallest hash result 692 and the largest hash result 694 found within this sub-range. Note that even though the sub-range extends up to 0.40 the largest hash result is 0.39. Accordingly, data structure 610 formerly representing range 142 has been replaced by data structure 650 that represents this storage on computer node B using the two new sub-ranges. The new data structure 650 maybe created in different manners, for example by reusing data structure 610, by creating new data structure 650 and deleting data structure 610, etc., as will be appreciated by those of skill in the art. Data structure 650 may include a link 664 if the structure is implemented as a linked list.

To complete creation of the new sub-range data structures, in step 420 files that include key/value pairs pertaining to the former range 142 are now distributed between the two new sub-ranges. For example, because File1 only includes key/value pairs whose hash results falls within sub-range 260, this file identifier is placed into region 676. Similarly, because File3 only includes key/value pairs whose hash results falls within sub-range 270, this file identifier is placed into region 696. Because File2 includes key/value pairs whose hash results fall within both sub-ranges, this file identifier is placed into both region 676 and region 696. Accordingly, when searching for a particular key whose hash result falls within sub-range 260, only the files found in region 676 need be searched. Similarly, if the hash result falls within sub-range 270, only the files found within region 696 need be searched.

In an optimal situation, no files (such as File2) overlap both sub-ranges and the amount of data that must be searched through is cut in half when searching for a particular key.

### Reading Key/Value Pairs

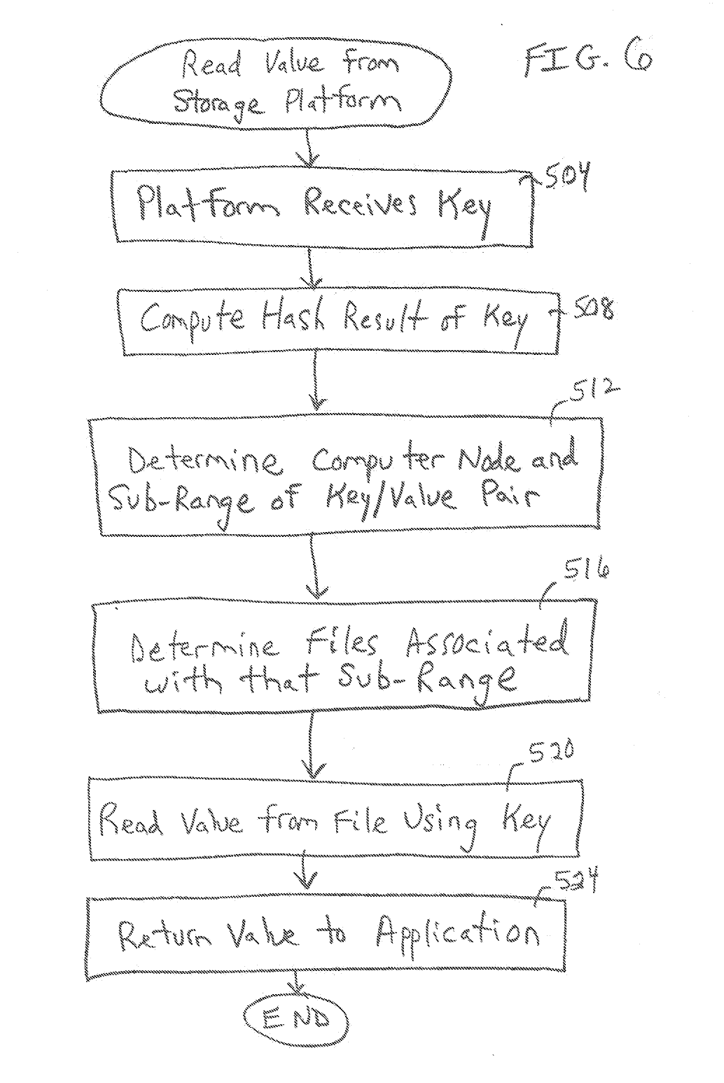

FIG. 6 is a flow diagram describing an embodiment in which a value is read from a storage platform. Previously, as described above, a particular key/value pair has been written to a particular storage platform and now it is desirable to retrieve a value using its corresponding key. Of course, it is possible that the value desired has not previously been written to the platform, in which case the read process described below will return a null result. Of course, other storage platforms and collections of computer nodes used for storage other than the one shown may also be used.

In step 504 a suitable software application (such as an application shown in FIG. 1) desires to retrieve a particular value corresponding to a key, and it transmits that key over a computer bus, over a local area network, over a wide area network, over an Internet connection, or similar, to the particular storage platform that is storing key/value pairs. This request for a particular value based upon a particular key may be received by one of the computer storage nodes of the platform (such as one of nodes A-F) or may be received by a dedicated computer node of the platform that handles such requests.

In step 508 the appropriate computer node computes the hash result of the received key using the hash function (or hash table or similar) that had been previously used to store that key/value pair within the platform. For example, computation of the hash result results in a number that falls somewhere within the range shown in FIG. 2.

In step 512 this hash result is used to determine the computer node on which the key/value pair is stored and the particular sub-range to which that key/value pair belongs. For example, should the hash result fall between points 122 and 124, this indicates that computer node B holds the key/value pair. And, within that range 142, should the hash result fall, for example, between points 252 and 124, this indicates that the key/value pair in question is associated with sub-range 270 (assuming that the range for B has only been split once). No matter how many times a range or sub-range has been split, the hash result will indicate not only the node responsible for storing the corresponding key/value pair, but also the particular sub-range (if any) of that node.

Next, in step 516, the particular storage files of computer node B that are associated with sub-range 270 are determined. For example, these storage files may be determined as explained above with respect to FIG. 8 by accessing the range manager data structure 650 for node B, and determining that since the hash result is greater than or equal to 0.29, that the storage files are listed at 696, namely, files File2 and File 3. Advantageously, computer node B need not search through all of its storage files that store all of its key/value pairs. Only the files that are associated with sub-range 270 need be searched, potentially reducing the amount of data to search by half. As the range becomes split more and more, the amount of data to search through is reduced more and more. If there are M splits, the amount is reduced potentially to 1/(M+1) of the total data stored on that computer node.

Once the relevant files are determined, then in step 520 computer node B searches through those files (e.g., File2 and File 3) and reads the desired value from one of those files using the received key. Any of a variety of searching algorithms may be used to find a particular value within a number of files using a received key. In one embodiment, an index file such as shown in FIG. 9 may be used. For example, given a key, k(k), one determines between which keys in the first column of index file 702 the key k(k) falls. Assuming that k(k) falls between k(i) and k(j) of file 702 (rows 720 and 730), then that range of key/value pairs between rows 712 and 714 are retrieved from file 704 (e.g., 64k of pairs) into memory. The given key k(k) is then searched for (using, e.g., a binary search) within that range and is found in a simple manner, and the value is read. Next, in step 524 the value that has been read is returned to the original software application that had requested the value.

### File Compaction

Periodically, files containing key/value pairs may be compacted (or merged) in order to consolidate pairs, to make searching more efficient, and for other reasons. In fact, the process of file merging may be performed even for ranges that have not been split, although merging does provide an advantage for split ranges.

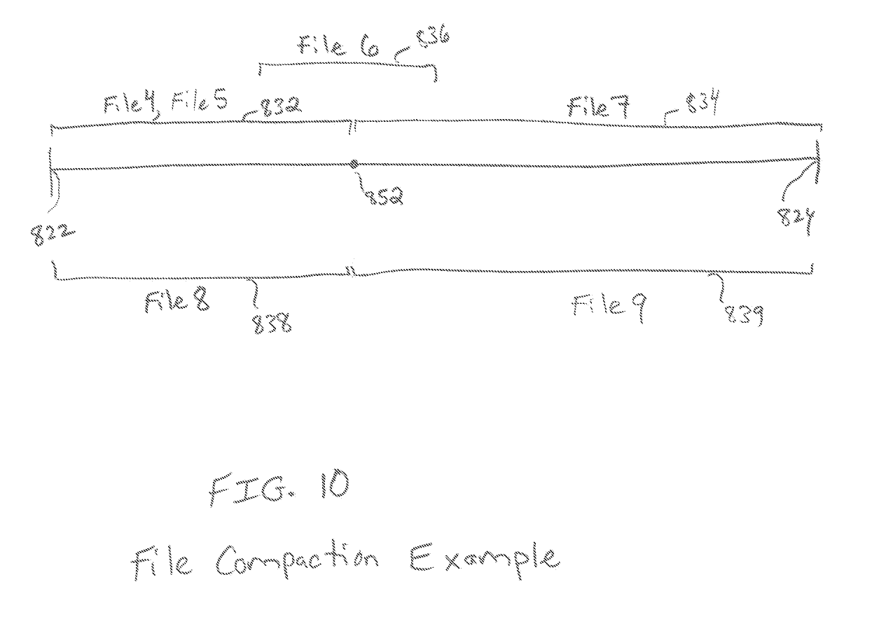

FIG. 10 illustrates a situation in which, at one point in time, the single range from 822 to 824 exists and a number of files File4, File 5, File6 and File7 have been written to and include key/value pairs. Once the range is split at point 852, it is determined that File4 and File5 include pairs whose hash results fall to the left of point 852 (in region 832), that File7 include pairs whose hash results fall to the right of point 852 (in region 834), and that File6 include pairs whose hash results fall to the right of point 852 and to the left (for example, by reference to the smallest and largest hash result of each file). Thus, File6 will be shared between the two new subranges, much like File2 of FIG. 8.

The file compaction process iterates over each pair in a file, iterating over all files for a range or subranges of a node, and determines with which subrange a pair belongs (by reference to the hash result associated with each pair). If a range of a node has not been split, then all pairs belong to the single range. All pairs belonging to a particular subrange are put into a single file or files associated with only that particular subrange. Existing files may be used, or new files may be written.

For example, after File4, File5, File6 and File7 are merged, a new File8 is created that contains File4, File5, and those pairs of File6 whose hash results falls to the left of point 852. New File9 is created that contains File7 and those pairs of File6 whose hash results falls to the right of point 852. One advantage for reading a key/value pair is that once a file pertaining to a particular subrange is accessed after compaction (before other files are written), then it is guaranteed that, the file will not contain any pairs whose hash result is outside of the particular subrange. I.e., file compaction is a technique that can be used to limit the number of SSTables that are shared between sub-ranges. If a range has not been split, and for example five files exist, then all of these files may be merged into a single file.

### Computer System Embodiment

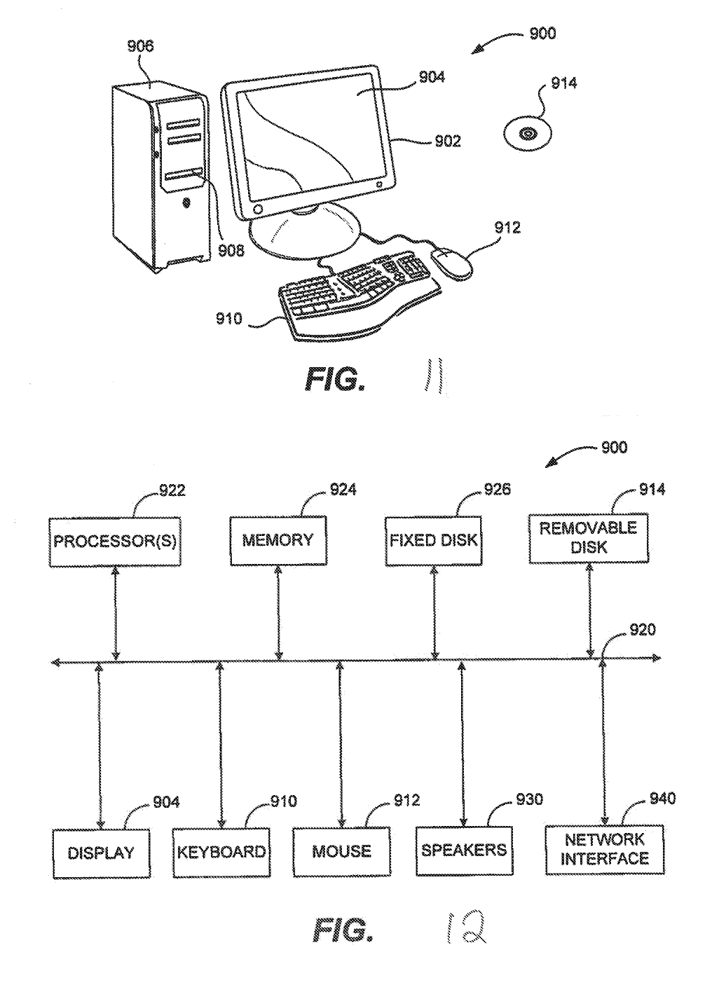

FIGS. 11 and 12 illustrate a computer system 900 suitable for implementing embodiments of the present invention. FIG. 11 shows one possible physical form of the computer system. Of course, the computer system may have many physical forms including an integrated circuit, a printed circuit board, a small handheld device (such as a mobile telephone or PDA), a personal computer or a super computer. Computer system 900 includes a monitor 902, a display 904, a housing 906, a disk drive 908, a keyboard 910 and a mouse 912. Disk 914 is a computer-readable medium used to transfer data to and from computer system 900.

FIG. 12 is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data and the like and is typically a secondary mass storage medium (such as a hard disk, a solid-state drive, a hybrid drive, flash memory, etc.) that can be slower than primary storage but persists data. It will be appreciated that the information retained within fixed disk 926, may, in appropriate cases, be incorporated in standard fashion as virtual memory in memory 924. Removable disk 914 may take the form of any of the computer-readable media described below.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

I claim:

1. A method of splitting a range of a computer node in a distributed hash table, said method comprising:
writing a plurality of key/value pairs to a computer node using a distributed hash table and a hash function, said pairs being stored in a plurality of files on said computer node, each of said keys having a corresponding hash value as a result of said hash function;
determining that an amount of data represented by said written pairs has reached a predetermined size;
splitting a range of said computer node in said distributed hash table into a first sub-range and a second sub-range by choosing a split value within said range; and
storing an identifier for each of said files having stored keys whose hash values fall below said split value in association with said first sub-range on said computer node and storing an identifier for each of said files having stored keys whose hash values fall above said split value in association with said second sub-range on said computer node.

2. The method as recited in claim 1 further comprising:
receiving a read request at said computer node that includes a request key;
computing a request hash value of said request key that falls below said split value using said hash function; and
retrieving a request value corresponding to said request key from one of said files by only searching through said files associated with said first sub-range, and not searching through said files associated with said second sub-range.

3. The method as recited in claim 2 further comprising:
returning said request value to a requesting computer where said read request originated.

4. The method as recited in claim 2 further comprising:
retrieving said request value by only searching through an amount of data that is no greater than said predetermined size.

5. The method as recited in claim 1 further comprising:
receiving a read request at said computer node that includes a request key; and
retrieving a request value corresponding to said request key from said computer node by only searching through an amount of data that is no greater than said predetermined size.

6. The method as recited in claim 1 further comprising:
receiving a write request at said computer node that includes a request key and a request value;
computing a request hash value of said request key that falls above said split value using said hash function;
storing said request key together with said request value in a first file in said computer node; and
storing an identifier for said first file in association with said second sub-range on said computer node.

7. The method as recited in claim 1 wherein said split value is approximately in the middle of said range.

8. The method as recited in claim 1 wherein said split value is chosen such that an amount of data in said files associated with said first sub-range is approximately equal to the amount of data in said files associated with said second sub-range.

9. A method of reading a value from a storage platform, said method comprising:
receiving a request key from a requesting computer at said storage platform and computing a request hash value of said request key using a hash function;
selecting a computer node within said storage platform based upon said request hash value and a distributed hash table, said computer node including a plurality of files storing key/value pairs;
based upon said request hash value, identifying a subset of said files on said computer node that store a portion of said key/value pairs;
searching through said subset of said files using said request key in order to retrieve said value corresponding to said request key, at least one of said files not in said subset not being searched; and
returning said value corresponding to said request key to said requesting computer.

10. The method as recited in claim 9 further comprising:
only searching through approximately half of said files on said computer node in order to retrieve said value.

11. The method as recited in claim 9 further comprising:
comparing said request hash value to a split value of a range of said computer node in said distributed hash table; and
identifying said subset of said files based upon said comparing.

12. The method as recited in claim 9 further comprising:
comparing said request hash value to a minimum hash value and to a maximum hash value of a sub-range of a range of said computer node in said distributed hash table; and
identifying said subset of said files based upon said comparing.

13. A method of writing a key/value pair to a storage platform, said method comprising:
receiving said key/value pair from a requesting computer at said storage platform and computing a hash value of said key using a hash function;
selecting a computer node within said storage platform based upon said hash value and a distributed hash table, a range of said computer node in said distributed hash table having a first sub-range below a split value and having a second sub-range above said split value;
storing said key/value pair in a first file on said computer node;
determining that said first file belongs with said first sub-range; and
storing an identifier for said first file in association with said first sub-range on said computer node.

14. The method as recited in claim 13 further comprising:
determining that said first file belongs with said first sub-range by determining that all key/value pairs of said first file have hash values that fall below said split value.

15. The method as recited in claim 13 further comprising:
receiving said key in a read request from a requesting computer at said storage platform and computing said hash value of said key using said hash function;
based upon said hash value, identifying said first file on said computer node, said first file being one of the plurality of files storing key/value pairs on said computer node; and
searching through said first file using said key in order to retrieve said value corresponding to said key, at least one of said files not being searched.

16. The method as recited in claim 15 further comprising:
only searching through approximately half of said files on said computer node in order to retrieve said value.

17. The method as recited in claim 15 further comprising:
comparing said hash value to said split value; and
identifying said first file based upon said comparing.

18. The method as recited in claim 15 further comprising:
comparing said hash value to a minimum hash value and to a maximum hash value of said first sub-range; and
identifying a first file based upon said comparing.

19. The method as recited in claim 1 wherein a shared one of said files includes keys whose hash values fall below said split value and includes keys whose hash values fall above said split value, said method further comprising:
merging said files to produce only a first file that includes keys whose hash values fall below said split value and a second file that includes keys whose hash values fall above said split value, said pairs of said shared file being distributed between said first file and second file.

20. The method as recited in claim 13 wherein said first file includes keys whose hash values fall below said split value and includes keys whose hash values fall above said split value, said method further comprising:
merging said first file to produce only a second file that includes keys whose hash values fall below said split value and a third file that includes keys whose hash values fall above said split value, said keys of said shared file being distributed between said second file and third file.
